(19) United States
(12) Patent Application Publication
(10) Pub. No.: US 2026/0244624 A1
(43) Pub. Date: Aug. 20, 2026

(54) COMPUTING DEVICE CONFIGURATION BASED ON LATENT SPACE SEARCH

(71) Applicant: Telefonaktiebolaget LM Ericsson (publ), Stockholm (SE)

(72) Inventors: Leif JONSSON, Hässelby Villastad (SE); Aliaksandr SAMSON, Stockholm (SE); Selim ICKIN, Stocksund (SE); Carolyn CARTWRIGHT, Stockholm (SE)

(21) Appl. No.: 18/876,761

(22) PCT Filed: Jun. 30, 2022
(86) PCT No.: PCT/EP2022/068158

§ 371 Date: Dec. 19, 2024

(51) Int. Cl. G06F 16/2455; G06F 16/906; G06N 20/00; H04L 41/0806; H04L 41/16

(52) U.S. Cl. CPC G06F 16/2456; G06F 16/906; G06N 20/00; H04L 41/0806; H04L 41/16

(57) ABSTRACT

A computer-implemented method is provided performed by a network node to generate and return a configuration of a computing device in a network. The method includes receiving data including an observation and an intent. The method further includes generating, with a first ML model, a plurality of configurations for the computing device for a second time interval based on a search on a plurality of latent variables in a latent space. The method further includes returning from the search a configuration for the computing device for the second time interval that best satisfies a performance metric and/or KPI of the intent based on the search, wherein the configuration is constrained by the intent. The method further includes transmitting the configuration for the computing device.

### TECHNICAL FIELD

The present disclosure relates generally to methods performed by a network node to generate and return a configuration of a computing device in a network based on a latent space search, and related methods and apparatuses.

### BACKGROUND

Power efficiency and green computing are an urgent global movement (e.g., United Nation climate goals), and sustainable and power-efficient solutions are being sought.

With respect to machine learning (ML) models, an approach in the telecommunications industry includes explainable artificial intelligence (AI). For example, some existing approaches focus on interpreting results of external ML models in lieu of decision-making. A variational autoencoder (VAE) ML model is a technique referenced in some research. In some approaches, a VAE is used in a “what-if” type of explanation, providing counterfactual explanations to a subject ML model's decisions. See e.g., patent publication number WO2022089741A1 which includes discussion of interpreting decisions of several different ML models post-hoc. Post-hoc interpretation, however, may make such a system multi-staged and, as a result, hard to interpret.

Representation learning is another area that may be used for efficient ML. For example, a generative conditional VAE ((C)VAE) model may help to compress large size datasets into meaningful and smaller size representations.

In some approaches, a ML model may be represented by a single generative model, by construction, that may attempt to learn to generate “what-if” explanations by the means of conditioning a latent space on a target variable desired to be optimized. This approach, however, may have poor generalization qualities outside the given dataset because the condition variables come from the training set. Thus, such approaches may suffer if the training dataset is small and not fully representative.

As a consequence, in some cases, a method may be lacking that can provide a realistic/optimized configuration for a computing device in a network.

### SUMMARY

There currently exist certain challenges. A method to provide a configuration of a computing device from a ML model that is both interpretable and can generate previously unobserved, yet realistic/optimal, values may be lacking.

Certain aspects of the disclosure and their embodiments may provide solutions to these or other challenges.

In various embodiments of the present disclosure, a computer-implemented method performed by a network node to generate and return a configuration of a computing device in a network is provided. The method includes receiving data comprising (i) an observation for the computing device or the network for a second time interval. The observation comprises one or more of a plurality of configurations of the computing device, a plurality of performance metrics, and/or a plurality of key performance indicators, KPIs, and (ii) an intent comprising one or more of a performance metric, a KPI, and a configuration parameter. The method further includes generating, with a first ML model, a plurality of configurations for the computing device for the second time interval based on a search on a plurality of latent variables in a latent space. The method further includes returning, from the search, a configuration for the computing device for the second time interval that best satisfies the performance metric and/or the KPI of the intent based on the search. The configuration is constrained by at least one of the performance metric, the KPI, and the configuration parameter of the intent. The method further includes transmitting the configuration for the computing device.

In other embodiments, a network node is provided. The network node is configured to generate and return a configuration of a computing device in a network. The network node includes processing circuitry; and at least one memory coupled with the processing circuitry. The memory includes instructions that when executed by the processing circuitry causes the network node to perform operations. The operations include to receive data comprising (i) an observation for the computing device or the network for a second time interval. The observation comprises one or more of a plurality of configurations of the computing device, a plurality of performance metrics, and/or a plurality of key performance indicators, KPIs, and (ii) an intent comprising one or more of a performance metric, a KPI, and a configuration parameter. The operations further include to generate, with a first ML model, a plurality of configurations for the computing device for the second time interval based on a search on a plurality of latent variables in a latent space. The operations further include to return, from the search, a configuration for the computing device for the second time interval that best satisfies the performance metric and/or the KPI of the intent based on the search. The configuration is constrained by at least one of the performance metric, the KPI, and the configuration parameter of the intent. The operations further include to transmit the configuration for the computing device.

In other embodiments, a network node is provided that is configured to generate and return a configuration of a computing device in a network. The network node is adapted to perform operations. The operations include to receive data comprising (i) an observation for the computing device or the network for a second time interval. The observation comprises one or more of a plurality of configurations of the computing device, a plurality of performance metrics, and/or a plurality of key performance indicators, KPIs, and (ii) an intent comprising one or more of a performance metric, a KPI, and a configuration parameter. The operations further include to generate, with a first ML model, a plurality of configurations for the computing device for the second time interval based on a search on a plurality of latent variables in a latent space. The operations further include to return, from the search, a configuration for the computing device for the second time interval that best satisfies the performance metric and/or the KPI of the intent based on the search. The configuration is constrained by at least one of the performance metric, the KPI, and the configuration parameter of the intent. The operations further include to transmit the configuration for the computing device.

In other embodiments, a computer program comprising program code is provided to be executed by processing circuitry of a network node configured to generate and return a configuration of a computing device. Execution of the program code causes the network node to perform operations. The operations include to receive data comprising (i) an observation for the computing device or the network for a second time interval. The observation comprises one or more of a plurality of configurations of the computing device, a plurality of performance metrics, and/or a plurality of key performance indicators, KPIs, and (ii) an intent comprising one or more of a performance metric, a KPI, and a configuration parameter. The operations further include to generate, with a first ML model, a plurality of configurations for the computing device for the second time interval based on a search on a plurality of latent variables in a latent space. The operations further include to return, from the search, a configuration for the computing device for the second time interval that best satisfies the performance metric and/or the KPI of the intent based on the search. The configuration is constrained by at least one of the performance metric, the KPI, and the configuration parameter of the intent. The operations further include to transmit the configuration for the computing device.

In other embodiments, a computer program product is provided comprising a non-transitory storage medium including program code to be executed by processing circuitry of a network node configured to generate and return a configuration of a computing device in a network. Execution of the program code causes the network node to perform operations. The operations include to receive data comprising (i) an observation for the computing device or the network for a second time interval. The observation comprises one or more of a plurality of configurations of the computing device, a plurality of performance metrics, and/or a plurality of key performance indicators, KPIs, and (ii) an intent comprising one or more of a performance metric, a KPI, and a configuration parameter. The operations further include to generate, with a first ML model, a plurality of configurations for the computing device for the second time interval based on a search on a plurality of latent variables in a latent space. The operations further include to return, from the search, a configuration for the computing device for the second time interval that best satisfies the performance metric and/or the KPI of the intent based on the search. The configuration is constrained by at least one of the performance metric, the KPI, and the configuration parameter of the intent. The operations further include to transmit the configuration for the computing device.

Certain embodiments may provide one or more of the following technical advantages. The method may provide a configuration of a computing device from a ML model that is both interpretable and can generate previously unobserved, yet realistic/optimal, values.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signaling diagram illustrating an overview of operations of a method in accordance with some embodiments of the present disclosure;

FIG. 2 is schematic diagram illustrating operations of an example embodiment in accordance with the present disclosure;

FIG. 3 is schematic diagram illustrating operations of an example embodiment in accordance with the present disclosure;

FIG. 4 is schematic diagram illustrating operations in accordance with some embodiments of the present disclosure;

FIG. 5 is a schematic diagram of a deployment of the functionality of a network node in accordance with some embodiments of the present disclosure;

FIGS. 6-10 are flow charts of operations of a network node in accordance with some embodiments of the present disclosure;

FIG. 11 is a block diagram of a network in accordance with some embodiments of the present disclosure;

FIG. 12 is a block diagram of a computing device in accordance with some embodiments of the present disclosure;

FIG. 13 is a block diagram of a network node in accordance with some embodiments of the present disclosure; and

FIG. 14 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As used herein, the term “network node” refers to equipment capable, configured, arranged, and/or operable to generate and return a configuration of a computing device in a network. As discussed further herein, examples of network nodes include, but are not limited to, centralized or distributed base stations (BS) in a radio access network (RAN) (e.g., g Node Bs (gNBs), evolved Node Bs (eNBs), core network nodes, access points (APs) (e.g., radio access points) etc.); a centralized or distributed network data analytics function (NWDAF) in a third generation partnership (3GPP) network; an r-app in non-real time RAN intelligent controller (RIC) in an open RAN (O-RAN), etc.

As used herein, the term “network” refers to any type of communication network. As discussed further herein, examples of a network include, but are not limited to, a telecommunication network that includes an access network, such as a RAN, and a core network, which includes one or more core network nodes. The access network may include one or more access nodes, or any other similar 3GPP access node or non-3GPP access point. The network nodes may facilitate direct or indirect connection of a computing device over one or more wired or wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the network may include any number of wired or wireless networks, network nodes, computing devices, and/or any other components or systems that may facilitate or participate in the communication of data and/or signals whether via wired or wireless connections. The network may include and/or interface with any type of communication, telecommunication, data, cellular, radio network, and/or other similar type of system.

As used herein, the term “computing device” refers to equipment capable, configured, arranged, and/or operable to be programmed to execute a configuration for the computing device. As discussed further herein, examples of computing devices include, but are not limited to, a customer node in the network, a node communicatively connected to a customer node in the network, etc.

While embodiments herein are explained in the non-limiting context of a ML model that solves an energy efficient task, the invention is not so limited. Instead, the method of the present disclosure may be used for generating and returning a configuration for a computing device in a network for any task in the network that best satisfies a performance metric and/or key performance indicator (KPI) of an intent based on a latent space search (as discussed further herein).

As used herein, the term “best satisfies” refers to a configuration (e.g., from a plurality of configurations) generated in the latent space search that results in a closest match to satisfying the intent. For example, a configuration that results in the closest value to a desired energy performance (e.g., a lowest energy value), while satisfying at least one of a plurality of conditions (e.g., a KPI(s) (e.g., a throughput value, a latency value, etc.), a PM value, and/or configuration parameter value) by being at a closest point to the intent representation.

Some approaches that include interpretation of decisions of different ML models post-hoc may present certain challenges, such as the system being multi-staged and, as a result, hard to interpret. For example, such an approach may lack sustained interpretability of the ML models during training so that both expert rules and data-driven learnings are trained hand-in-hand. Furthermore, it may be unclear regarding how errors propagate between the different ML modeling stages since different ML models are included that may not share the same mathematical ground. For example, one ML model may use graphical networks (e.g., Bayesian networks) to predict output parameters. Presently, however, there may be no known methods that guarantee that a learnt Bayesian network is consistent with reality and, thus, it can produce faulty estimates. Yet another challenge with a multi-stage approach may be the explainability. Since there are several ML models involved that may be trained in different ways, it may be difficult to know how the different ML models affect the final result, and it may be even more difficult to explain this with accuracy.

Possible challenges may also exist with approaches that have a single generative model that attempts to learn to generate “what if” explanations by conditioning a latent space on a target variable(s) desired to be optimized. For example, there may be poor generalization qualities outside a given dataset because condition variables come from a training set. Thus, unless there is an abundance of data (which often may not be the case), the ML model may yield results that are limited to the training set. From the perspective of energy efficiency, for example, if one desires low values of energy (e.g., what may appear as unrealistically low energy values), the ML model may not generate a result. As a consequence, such a ML model, may not present an optimal solution because the ML model may not generate a result in such circumstances. Additionally, such a ML model may not handle categorical data, such as text labels, well, and may not handle missing values in data, which may be common when working with real world data such as configuration management attributes in a system.

Thus, a method may be lacking that can solve tasks in a network, such as an energy efficiency task, where the method is both interpretable and can generate previously unobserved, yet realistic/optimal values. For example, a method may be lacking in a telecommunications network for generating realistic/optimal programmable computing device (e.g., customer node) settings based on performance metrics/KPIs.

Additionally, a method may be lacking that can handle missing and categorical data.

Certain aspects of the disclosure and their embodiments may provide solutions to these or other challenges. In some embodiments, a computer-implemented method includes use of a ML system based on a deep learning model (e.g., a generative ML model such as a version of a VAE, a GAN, a normalizing flow, etc.) to generate and return a configuration of a computing device (e.g., an existing customer node(s) deployed in the field in a network based on one or more of its current configuration management (CM) settings, performance metric counters (PM), and/or key performance indicators (KPIs) derived from PMs.

In some embodiments, the computer-implemented method is performed by a network node to generate and return a configuration of a computing device in a network. The method includes receiving data comprising (i) an observation for the computing device or the network for a second time interval. The observation includes one or more of a plurality of configurations of the computing device, a plurality of performance metrics, and/or a plurality of key performance indicators, KPIs, and (ii) an intent comprising one or more of a performance metric, a KPI, and a configuration parameter. The method further includes generating, with a first ML model, a plurality of configurations for the computing device for the second time interval based on a search on a plurality of latent variables in a latent space. The method further includes returning, from the search, a configuration for the computing device for the second time interval that best satisfies the performance metric and/or the KPI of the intent based on the search. The configuration is constrained by at least one of the performance metric, the KPI, and the configuration parameter of the intent. The method further includes transmitting the configuration for the computing device.

The first ML model may be trained on a combination of configurations of the computing device (e.g., configuration management parameters (CM)), performance metrics (PM) (e.g., performance management counters), and/or KPIs derived from the PM counters, combined into a single dataset. The first ML model may then learn to map observations into a latent space and reconstruct the original observations from samples with additional noise (e.g., in a VAE training procedure). In some embodiments, the first ML model is augmented to handle categorical data as well as missing values. “What-if” explanations may then be generated using a search procedure via exploration of a latent space, while constraining the procedure by one or more original KPIs (e.g., to keep original performance constraints), configuration parameters, and performance metrics (e.g., to minimize energy consumption at the same time).

As a consequence of the generality of the method, the framework may be capable of optimizing any parameter and, thus, is not restricted to energy-related counters. For example, the method may work on any system having configuration parameters that control a behavior and that outputs metrics that report the current status of the system (e.g., metrics similar to PM counters) on the behavior of interest.

The method may output/return a new configuration (e.g., configuration management (CM)) instance), which may yield an optimized performance (e.g., an optimized energy performance), while respecting a desired/intended network performance KPI(s) (e.g., throughput, latency, etc.), PM, and/or configuration parameter. Due to the construction of the first ML model and the latent space search, as discussed further herein, the method may provide safe-guarding against generation of unrealistic CM settings.

In contrast to other approaches, the method of the present disclosure includes one integrated mathematical ML model and, as a consequence, the first ML model may be mathematically coherent.

Moreover, the method may not need re-training of the first ML model (e.g., a VAE) to generate explanations for another variable(s). Rather, a latent space search (as discussed further herein) is performed (which may be fast) to generate a proposal for other desired variables within a given dataset.

Additionally, in some embodiments, the method can handle missing values in data, different datatypes, and may optimize for any given variable in a training set of data (e.g., the method can be applied to problems other than optimizing energy performance).

The latent space search procedure may return realistic/optimal proposal values which can be constrained if there are external constrains (e.g., throughput cannot decrease).

The first ML model (e.g., VAE) may be trained with a goal to disentangle (e.g., factorize) latent (unobserved) variables, thereby making latent features interpretable.

The method includes generation of realistic/optimal values based on not conditioning the latent space on KPI categories. Instead, the method uses a layer (e.g., an optimization layer) where additional constraints are injected. Additionally, the latent space can be explored freely without restricting the method to training data.

In some embodiments, the first ML model of the method is enhanced with a second ML model (e.g., a long short term memory (LSTM) ML model to predict future realistic/optimal configurations.

Certain embodiments may provide one or more of the following technical advantages. Based on inclusion of one integrated mathematical ML model, it may be easier to explain how the output is generated. As a consequence, interpretability may be better than in approaches with several disconnected ML models. Moreover, the use of one integrated mathematical ML model, and not several ML models trained in different ways, may ensure some mathematical guarantees that several separate models cannot. For example, in some other approaches, if a one ML model is trained in one way, and a next ML model is trained in another way, and the ML models are not guaranteed to be consistent with a real-world model and are invoked in a series of actions, there may be errors that enter when moving between the ML models. For example, assumptions of one ML model may not be consistent with another ML model.

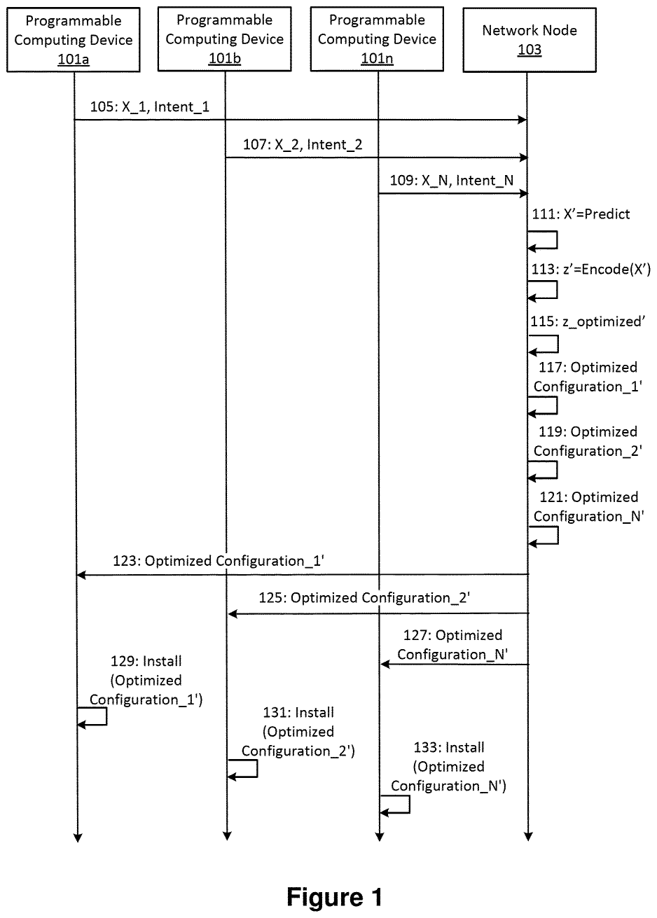

FIG. 1 is a signaling diagram illustrating an overview of operations of a method in accordance with some embodiments of the present disclosure. As illustrated, three programmable computing devices 101a, 101b, 101n are in communication with network node 103. While the example embodiment of FIG. 1 illustrates three computing devices, the method/network of the present disclosure is not so limited and may include any non-zero number of computing devices. The operations include signaling (in operations 105-109) a predicted network state X_1, X_2, X_N and intents Intent_1, Intent_2, Intent_3 (e.g., in metadata containing the respective intents) from programmable computing devices 101a, 101b, 101n, respectively, to network node 103. The intent may be included in a dictionary or other association of data that includes attributes that are associated with a desired criteria (e.g., sustain KPI_A at time t1, maximize KPI_B at time t2, etc.). In operation 111, network node 103, using a pretrained prediction ML model (also referred to herein as a “second ML model), predicts the X′_n (that is, the state for the next time step). In operation 113, a pretrained encoder of network node 103 encodes X′ to an embedding space, z′. Network node 103 comprises or is communicatively connected to a first ML model (also referred to herein as an “optimizer”). In operation 115, the optimizer optimizes the z′ given an intent of programmable computing device 101a, 101b, 101n. The optimization may be performed via a lookup table (or other data association) that includes received intents from programmable computing devices 101a, 101b, 101n. In operations 117-121, a pretrained decoder in network node 103 decodes/generates a respective optimized configuration for a next time step for programmable computing devices 101a, 101b, 101n, respectively, given the optimized latent space, z_optimized′. In operations 123-127, the generated optimized configurations (i.e., optimized configuration_1′, optimized configuration_2′, optimized configuration_N′) are sent to programmable computing devices 101a, 101b, 101n, respectively, for validation and installation. In operations 129-133, programmable computing devices 101a, 101b, 101n, respectively, install the recommended configurations.

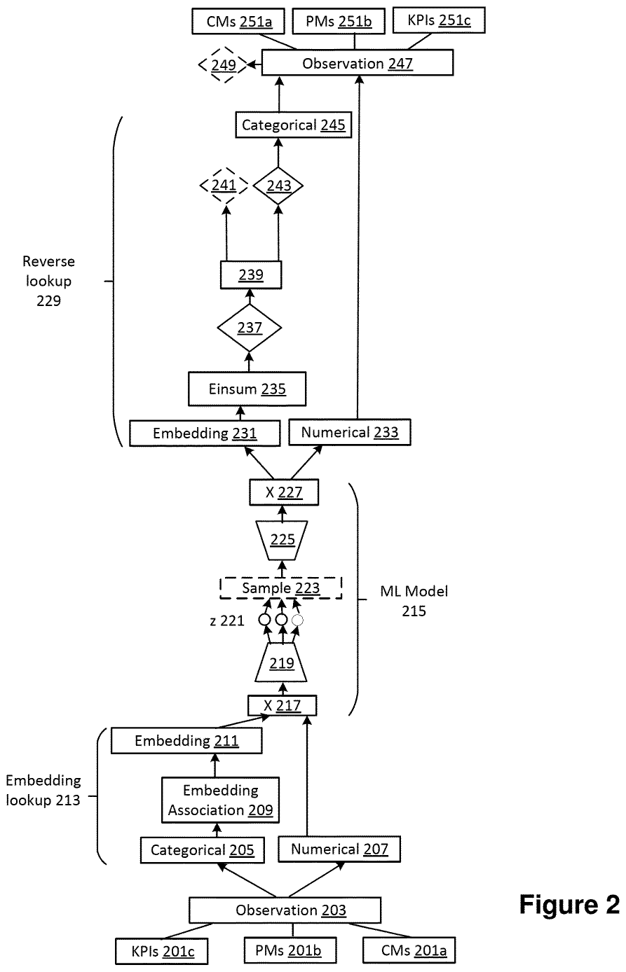

FIG. 2 is schematic diagram illustrating operations of an example embodiment in accordance with the present disclosure. In the example embodiment, operations shown with dashed lines are used only while training. A base model of the first ML model 215 may be a beta-VAE with beta cycling while training. After first ML model 215 (e.g., a VAE) is trained, first ML model 215 knows how to compress and reconstruct partially observed data. In an example embodiment, the method can optimize for desired properties or optimization of other KPIs, etc. For example, latent space may be explored in a search for the desired property/properties or optimization of a KPI(s), while keeping some KPIs, configuration parameters, and/or performance metrics unchanged. Input to the ML model 215 is a combination of CMs 201a, PMs 201b, and/or KPIs 201c of an observation 203. Categorical value handling may be useful as some features may be non-numerical. Categoricals 205 are handled using an embedding lookup 213 technique when encoding 219 that includes embedding categorial 205 in embedding association (e.g., an embedding table) 209 resulting in embedding 211 to obtain X 217. X 217 also may include numerical data 207. Embedded categorical data and/or numerical data 207 may be encoded using encoder 219 to a compressed representation, which may be used as a reference point for the search of latent space 221 as discussed further herein

Use of encoder 219 is optional, and its use depends on the search/optimizer 409 technique used in the search. In some embodiments, an encoded sample 223 may provide a good reference point for the search process, as discussed further herein.

A reverse embedding lookup 229 technique may be used while decoding 225, which may reduce memory overhead while training and operating. The reverse embedding lookup 229 technique may be multi-stage. First, an output reconstructed X 227 of the VAE 215 of this example embodiment is split into numerical 233 and embedding vectors 231, where an embedding vector 231 represents a single categorical feature. Then embedding 231, as well as embedding lookup table (or other data association) 235 are normalized and a product is computed, and the result is transformed into a probability distribution using a normalization function 237. The result 239 is a distribution over possible values for a particular variable in scope. While training, cross-entropy loss 241 for this distribution can be computed, and while inferencing an operation 243 can be taken over to get a prediction 245 for the most probable value.

For numerical features 233, a modified mean-squared error may be used (as discussed further herein regarding handling missing values). Total reconstruction loss may be a weighted combination of the above losses.

The categorical 245 output of the reverse lookup 229 and the numerical data 233 are transformed into observation 247, which is then compared with observation 203 (including CMs 251a, PMs 251b, and/or KPIs 251) using masked mean squared error (MSE) loss 249.as discussed further herein.

Still referring to FIG. 2, to promote disentanglement, while training, the method includes cycling through beta weight using a periodic function and then keeping it constant at a high value for a few epochs.

Disentanglement may be a potential technical advantage of the method. The first ML model may include an interpretable, factorized (i.e., disentangled) representation of compressed data. As a consequence, the method may not only compress the data, but also can associate each latent variable with the effect on the observation, which may promote interpretability of the first ML model. This may be achieved by training the first ML model with a beta-parameter (e.g., beta-VAE), and adjusting the beta-parameter to encourage interpretable compressed features.

As the data may be time-dependent (e.g., data having a high variation on 24-hour basis), in some embodiments, the method includes making use of the time-dependent data by first assuming the time variable lies on unit circle and then encoding it as a cyclic variable, using sine and cosine or other periodic function. Thus, the first ML model (e.g., a neural network) can have understanding that for example time 23:00 and 01:00 are separated by two hours rather than a twenty-two hour separation, which may enhance performance of the network by better understanding time information.

Thus, a further potential technical advantage may be that because, in some embodiments, the first ML model can handle different data types, the capture of interdependent features may be enhanced. In addition to numerical values with missing observations, in some embodiments, the method can handle categorical variables and can take advantage of a cyclic time variable.

Yet, a further potential technical advantage of the method may be provided based on that the method does not need to learn a graphical network structure. Rather, the first ML model of the method may be a generative ML model. Consequently, accuracy may be improved because there may not be a failsafe way to learn graphical structures. That is, there may be no guarantees that a graphical structure learned from data alone is consistent with reality and, as a consequence, such an approach may produce faulty inferences/predictions.

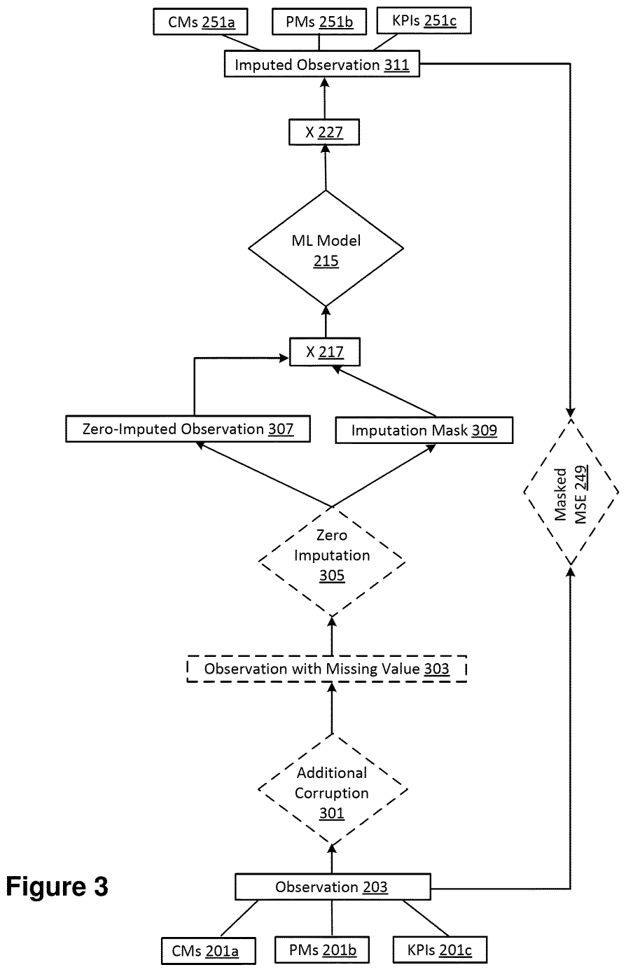

FIG. 3 is schematic diagram illustrating operations of an example embodiment in accordance with the present disclosure. In this example embodiment, optional operations are shown with dashed lines. The operations of FIG. 2 may be modified with the operations of FIG. 3 to handle an observation with a missing value(s), which may be common in, e.g., telecommunication data. For example, a few hours of data can be missing in a timeseries from PM counters, or a configuration attribute of a cell may be missing for a day, etc.

In this example embodiment, for categorical features, missing values are ordinally-encoded, along with the non-missing ones, resulting in an additional item in the lookup table (or additional entry in other data association).

For numerical features, zero-imputation 305 with masking 309 is included. In the example embodiment, data is included that is not imputed in pre-processing. Thus, a challenge may be present as the method cannot compare imputed values to anything. Thus, an operation may be included to perform additional spoiling/corruption 301. That is, introducing 301 additional missing data while training and then comparing imputed values to ground-truth. While training, operations may include additionally spoiling 301 data (observation 203), introducing a fraction of additionally missing values resulting in even more “corrupted” data (observation+) 303. Observation+ (from 303) is then zero-imputed 305 to obtain zero-imputed observation 307. Zero-imputed observation 309 is concatenated with a mask 309 indicating which values have been imputed to obtain x 217, which is fed into the VAE 215. VAE 215 outputs a reconstructed X 227 and transforms it into observation 311 (including CMs 251a, PMs 251b, and/or KPIs 251c), which is then compared not with observation+ 303 but with observation 203 using masked MSE loss 249 (which does not take missing values into account). This way the system learns not only to map partially-observed inputs to the same point in latent space but also to impute missing values that we additionally spoiled. During inference, the additional spoiling is omitted.

A complex interdependency of observed variables in telecommunications datasets (e.g., PM and CM datasets) may exist. As a consequence, in some approaches, naïve mean imputation may not be appropriate and additional prior step may be needed to impute missing values on individual attributes (see e.g., WO2022089741A1) as a part of pre-processing. Bayesian based imputation approaches might be computation heavy. In contrast, a further technical advantage of the present method may be that because imputation may be included as part of the training, a full distribution of observed values may be used to estimate the missing values, which may give a more realistic and holistic estimate.

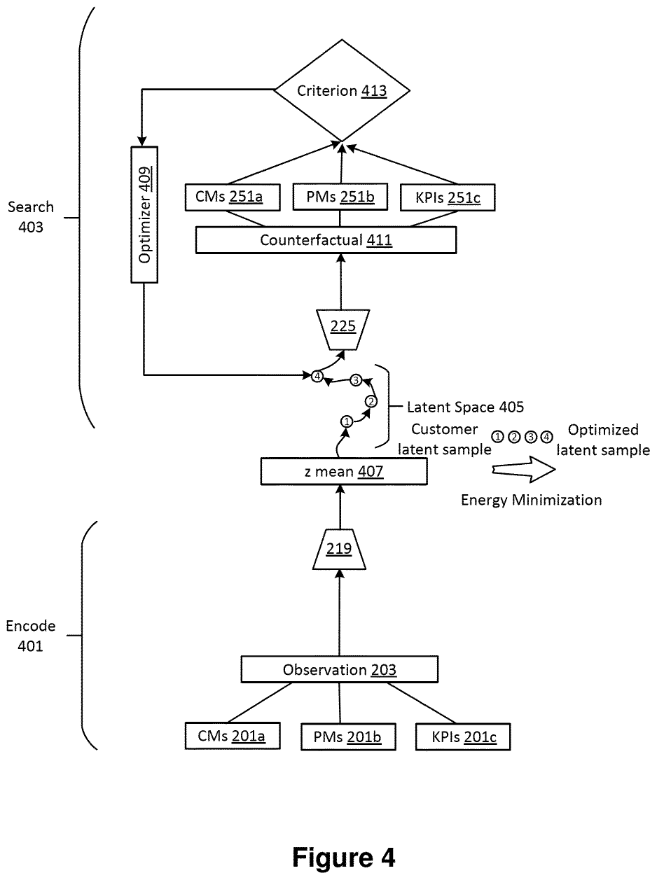

FIG. 4 is schematic diagram illustrating operations in accordance with some embodiments of the present disclosure. After first ML model 215 (e.g., a VAE) is trained, first ML model 215 knows how to compress and reconstruct partially observed data. As compressed representations of data (e.g., latent manifold) is smooth and meaningful (e.g., a property of well-trained VAE), this property may be exploited to explore the latent space 405 using more efficient gradient-based optimizers that do not require a costly global sampling stage.

In an example embodiment, the method can optimize for desired properties, such as minimization of energy, or optimization of other KPIs, etc. For example, latent space 405 may be explored in a search for a minimum of energy, while keeping some KPIs unchanged. Data XO (e.g., CMs 201, PMs 201b, KPIs 201c for an observation 203 from a computing device (e.g., a customer node in the network) is encoded 401 using encoder 219 to a compressed representation z mean 407, which may be used as a reference point for the search. In the latent space search, points in latent space z 405 (e.g., points 1, 2, 3, 4) are sampled, and the points are decoded 225 to the original space X 411 at each iteration of search 403. Each decoded point X (e.g., CMs 251a, PMs 251b, KPIs 251c) is passed to criterion function 413, designed around a particular goal (e.g., penalize for high energy and reward for decoded KPIs 251c to be as close as possible to KPIs of the customer). Optimizer 409 may be a differential evolution algorithm. This method, however, is flexible and other optimizers 409 as well as criterion 413 for optimization may be used. As a consequence, the framework may be general and not limited to a particular task.

Use of encoder 219 is optional, and its use depends on the optimizer/search 409 technique used. In some embodiments, an encoded sample may provide a good reference point for the optimization process.

Reduction in memory and disk space requirements on computation nodes, thus, may be another technical advantage. For example, a learned representation of a training dataset may be obtained in a compressed form of the original dataset. Thus, an original and potentially large dataset may be replaced with a learned representation, which may cause significant reduction in memory and disk space requirements on computation nodes.

In some embodiments, the method may further include predicting future observations. In an example embodiment, to provide relevant recommendations, a customer sample at time (t) (e.g., from computing device 101a) is propagated into the future for some desired time (t+1). This may be performed by, e.g., predicting the observation or by predicting the latent encoding. Although propagating latent encoding may be more efficient due to reduced dimensionality, propagating the raw observation from the customer sample may be more reliable. A second ML model (e.g., a LSTM model) may be used that is trained on the original dataset. The predicted observation then may be used as discussed herein to find a recommendation relevant for the desired time (t+1).

Thus, a further potential technical advantage may be flexibility. For example, training a ML model (e.g., a VAE) may be a time- and processing-intensive procedure. The method of the present disclosure may avoid having to retrain, e.g., a neural network if/when it is desired to optimize for something else than originally intended. Since finding a parameter(s) (e.g., optimal parameter(s) is performed by a latent space search procedure on learned latent variables, rather than direct mapping through an encoder/decoder, the method may be more flexible than other approaches (cf., e.g., WO2022089741A1).

Flexible exploration may be a further potential technical advantage. In some other approaches, a cVAE model may be used that is trained using conditioning only on values existing in the training data. When inferring recommendations, therefore, one may only demand a desired KPI to be in the range, limited by a corresponding distribution of observed values. As, otherwise, the generated recommendations are unlikely to be reliable. The method of the present disclosure, on the other hand, does not use conditioning. As a consequence, latent space values can deviate much further from the observed values, which may allow for exploration and generation of more creative/novel results.

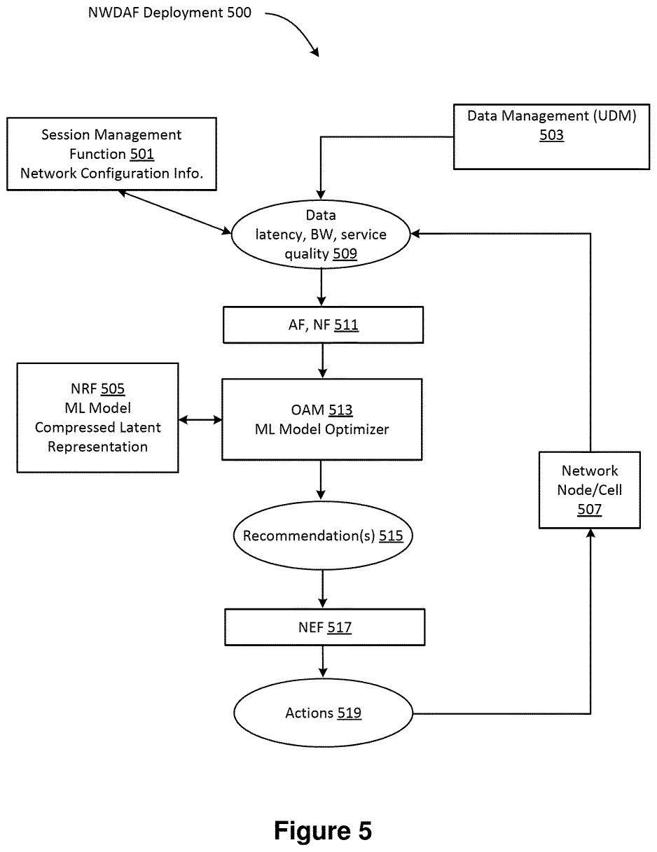

FIG. 5 is a schematic diagram of a deployment of the functionality of a network node (e.g., network node 103) in a network data analytics function (NWDAF) in accordance with some embodiments of the present disclosure. Raw data included in data and intents 509 may be obtained via observations from network nodes and cells 507 where preprocessing can be performed on unified data management (UDM) 503. Network configuration data may be obtained from session management function (SMF) 501. The raw data from data and intents 509 and network configuration data 501 may be fed together with the intent(s) 509 to operation and management (OAM) function 513 via application function (AF) and network function (NF) 511. ML model 215 optimizer (e.g., VAE optimizer including an evolutionary algorithm) may be located within the OAM 513, and may communicate with a Network Repository Function (NRF) 505. The obtained latent space may be located with the NRF 505 after pretraining. During deployment, the generated recommendations 515 (i.e., the configurations that are computed and fine-tuned to be optimum given the constraints) are sent to a Network Exposure Function (NEF) 517 where the recommended actions 519 may be executed. The consequences of the actions 519 on the network nodes and cells 507 may be obtained via measurements and fed back to the NWDAF in the form of a dataset 509.

In another embodiment, the network node/functionality of the network node (e.g., network node 103) of the present disclosure can be deployed as an rApp microservice operating in an open-RAN (ORAN) non-real time (non-RT) or near-RT RAN intelligent controller (RIC). An rApp includes, without limitation, O-RAN automation applications for automation use cases with more than one second automation loops. The controller (e.g., non-RT or near-RT RIC) may provide recommendations to change configurations in a network node or a cell. Such a platform may help to provide recommendations on cross-vendor and operator setting (e.g., a VAE model and an optimizer trained on one large dataset and deployed on one rApp can be mirrored and deployed on an rApp running on other datasets). In addition, latent representation also may be made available via an open interface as a separate rApp. As a consequence, ML model optimizers (e.g., VAE optimizers) for different vendors may reuse the shared learned representation.

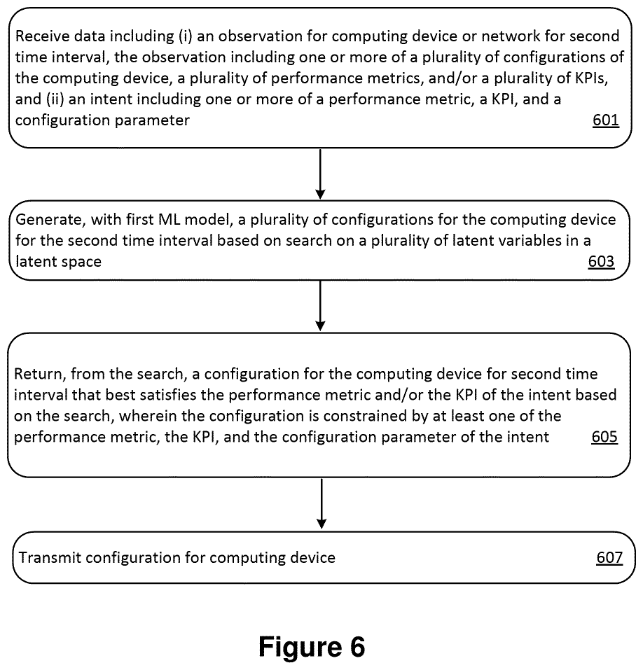

FIG. 6 is a flow chart illustrating operations of a computer-implemented method performed by a network node (e.g., network node 103, 11110, 13300 discussed herein) to generate and return a configuration of a computing device (e.g., computing device 101, 11114, 12300 discussed herein) in a network. The method includes receiving (601) data comprising (i) an observation for the computing device or the network for a second time interval. The observation comprises one or more of a plurality of configurations of the computing device, a plurality of performance metrics, and/or a plurality of key performance indicators, KPIs, and (ii) an intent comprising one or more of a performance metric, a KPI, and a configuration parameter. The method further includes generating (603), with a first ML model, a plurality of configurations for the computing device for the second time interval based on a search on a plurality of latent variables in a latent space. The method further includes returning (605), from the search, a configuration for the computing device for the second time interval that best satisfies the performance metric and/or the KPI of the intent based on the search. The configuration is constrained by at least one of the performance metric, the KPI, and the configuration parameter of the intent. The method further includes transmitting (607) the configuration for the computing device.

In some embodiments, the search on the plurality of latent variables in the latent space comprises one or more of (1) encoding the plurality of configurations of the computing device, the plurality of performance metrics, and/or the plurality of KPIs of the data to a compressed representation in the latent space, (2) sampling a plurality of points in the latent space, (3) decoding respective points in the plurality of points in the latent space to a respective plurality of decoded points, and (4) generating the configuration for the computing device on the performance metric and/or the KPI while satisfying the constrained at least one of the performance metric, the configuration parameter, and the KPI.

The data may comprise data for a first time interval, wherein a portion of the first time interval comprises missing data

The sampling may comprise accessing an association of a plurality of constraints comprising one or more of the KPI, the performance metric, and the configuration parameter.

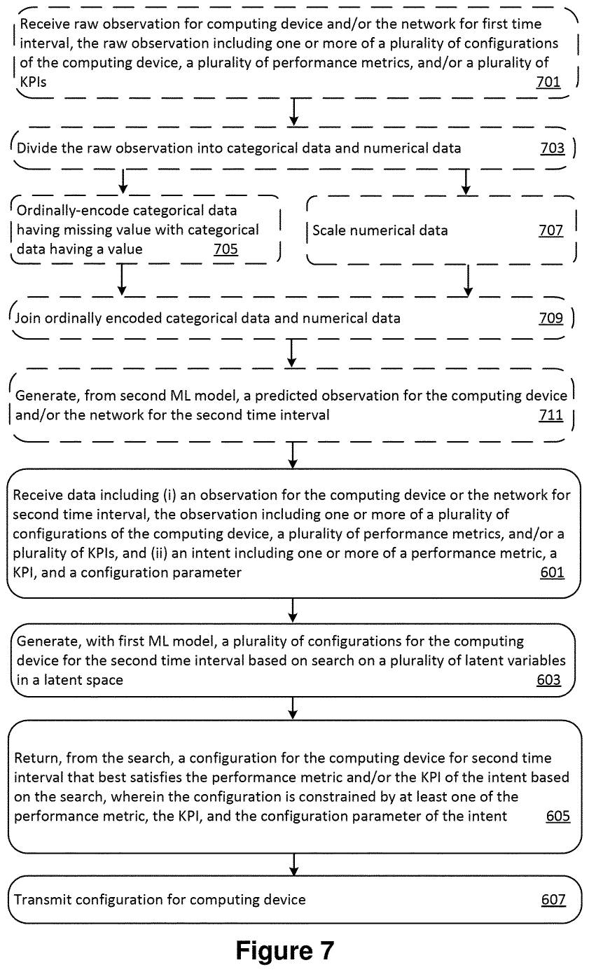

FIG. 7 is a flow chart illustrating further operations of the computer-implemented method performed by the network node in accordance with some embodiments. Before receiving the data in operation 601 of FIG. 6, the method may further optionally include pre-processing of the data. As illustrated in FIG. 7, pre-processing operations may include receiving (701) a raw observation for the computing device and/or the network for a first time interval. The raw observation may comprise one or more of a plurality of configurations of the computing device, a plurality of performance metrics, and/or a plurality of KPIs. The method may further include dividing (703) the raw observation into categorical data and numerical data.

The categorical data may comprise categorical data for the first time interval having a value and categorical data for the first time interval having a missing value. The method may further include ordinally-encoding (705) the categorical data having the missing value with the categorical data having a value; scaling (707) the numerical data; and joining (709) the ordinally encoded categorical data and the numerical data. The method may further include generating (711), from a second ML model, a predicted observation for the computing device and/or the network for the second time interval. The generating (711) may comprise propagating the data from the first time interval into the future for the second time interval. The propagating may comprise predicting the observation and predicting a latent encoding.

The second ML model may comprise a LSTM model and the predicting the predicted observation is performed with the LSTM model. The generating (603) of FIG. 6 may comprise using the predicted observation from operation 711 to find the configuration.

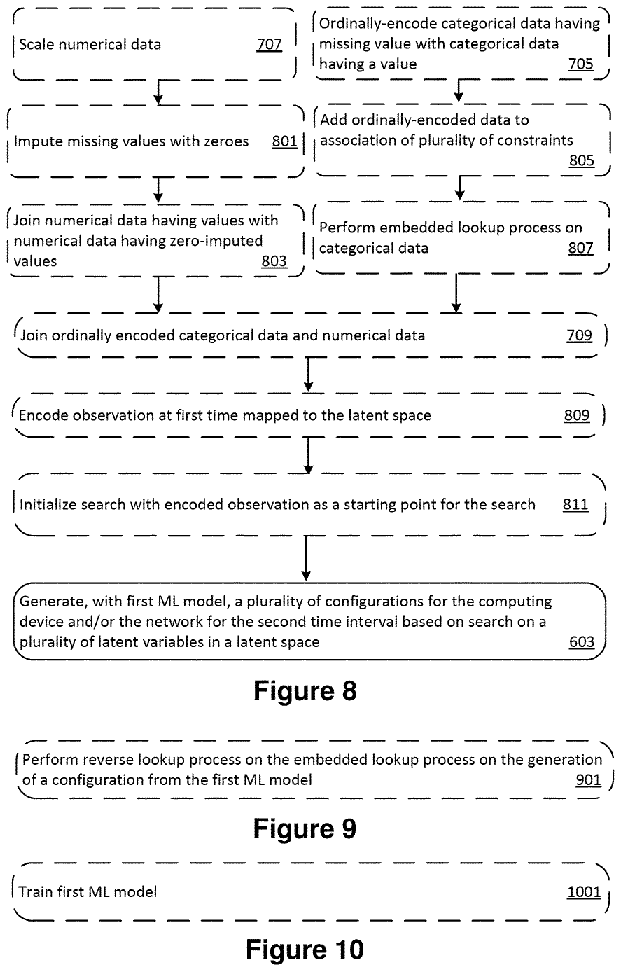

FIG. 8 is a flow chart illustrating further operations of the computer-implemented method performed by the network node in accordance with some embodiments. Before receiving the data in operation 601 of FIG. 6, the method may optionally include further pre-processing of the data. As illustrated in FIG. 8, further pre-processing operations of the method may further include missing value imputation for numerical data missing a value and/or compression of the numerical data (e.g., the numerical data from operation 707 and/or of the ordinally-encoded categorical data from operation 705). The further operations may include imputing (801) missing values in the numerical data with zeroes; and joining (803) the numerical data having values with the numerical data having zero-imputed values (e.g., with an imputation mask). The method may further include adding 805 the ordinally-encoded data to an association of the plurality of constraints (e.g., to a table); and performing (807) an embedded lookup process on the categorical data. The embedded lookup process may comprise one or more of (i) embedding the categorical data in an embedded association; and (ii) encoding the categorical data based on the embedded association. After joining (operation 709 of FIGS. 7 and 8) the ordinally encoded categorical data and the numerical data, the method may further include encoding 809 the observation at the first time mapped to the latent space; and initializing 811 the search of the first ML model with the encoded observation as a starting point for the search.

FIG. 9 is a flow chart illustrating further operations of the computer-implemented method performed by the network node in accordance with some embodiments. When the operations of FIGS. 6 and 8 include performing (807) the embedding lookup process on categorical data, after the generating (603) shown in FIGS. 6 and 7, the method may include a reverse lookup operation for categorical data (e.g., reverse lookup process 229 of FIG. 2). Thus, as shown in FIG. 9, the method may further include performing (901) a reverse lookup process on the embedded lookup process on the generation of a configuration from the first ML model. The reverse lookup process may comprise one or more of (i) dividing the generated configuration from the first ML model into a plurality of respective embedding vectors and a plurality of respective numerical vectors, wherein a respective embedding vector represents a single categorical feature of the categorical data; (ii) normalizing the respective embedding vectors and an association of a plurality of constraints comprising one or more of the KPI, the performance metric, and the configuration parameter; (iii) calculating a product of the normalized plurality of respective embedding vectors and the normalized embedded association data; and (iv) applying a normalizing function to the product to obtain a distribution over values for the configuration.

FIG. 10 is a flow chart illustrating further operations of the computer-implemented method performed by the network node in accordance with some embodiments. Before the method of any one of FIGS. 6-9 is performed in a deployment, the method may further include training (1001) the first ML model. The training may include training operations discussed herein with respect to FIGS. 2 and 3, including calculating a cross-entropy loss for a distribution over values for the configuration.

In some embodiments, the first ML model is a VAE and a further technical advantage may be improved training of the VAE. VAE training often may be challenging (e.g., due to phenomenon known as KL-vanishing). In some embodiments of the method of the present disclosure, a beta parameter may be cycled using a sine function while training, which may make the training process much faster.

In some embodiments, the computing device has a current configuration management setting, the performance metric comprises an energy performance metric, the KPI comprises a performance metric of the network, and the configuration of the computing device comprises another configuration management setting for the computing device.

In some embodiments, the first ML model comprises a generative ML model.

In some embodiments, the network comprises a RAN.

In some embodiments, the network node comprises a node in a networks data analytics function, NWDAF. For example, the network node may be deployed within a NWDAF part of a 3GPP network, as illustrated in FIG. 5. The network node may be distributed (e.g., NRF 505, OAM 513) may interact with a UDM (e.g., UDM 503) and multiple network nodes/cells 507 through standardized protocols, either directly or indirectly via other network functions in the network. Communication between the NWDAF 500 and RAN may include measured data 509 from the RAN, actions 519 to be taken.

In some embodiments, the network node comprises a rApp microservice operating in an open RAN, ORAN, non-real time or near-real time RAN intelligent controller, RIC. For example, In an O-RAN environment, the network node may include an r-App in a non-real time RIC, which may be part of a service management and orchestration functionality. The data and configuration may be transmitted over the A1 interface.

The various operations from the flow charts of FIGS. 7-10 may be optional with respect to some embodiments of network nodes and related methods.

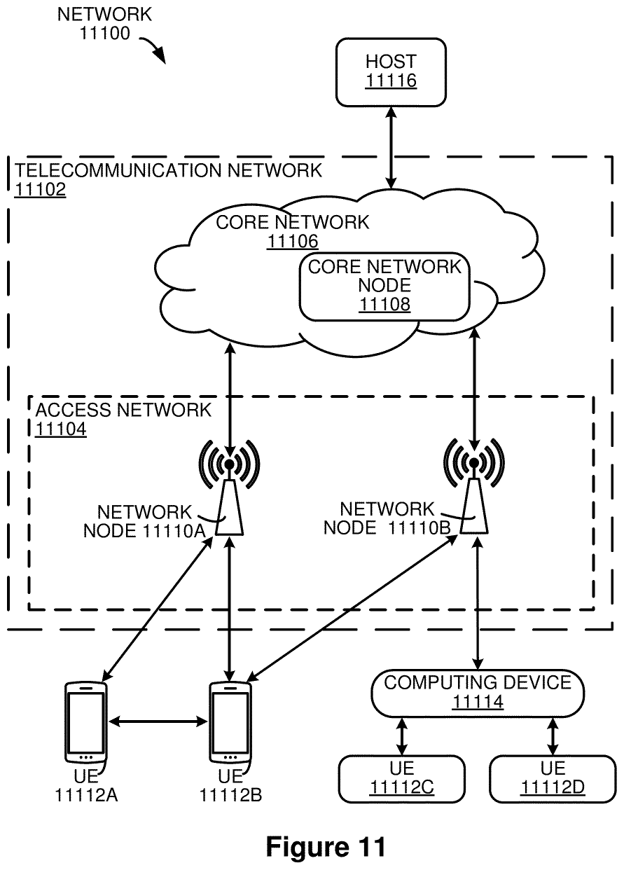

The method of the present disclosure may be performed by a network node (e.g., network node 103 of FIG. 1, network node 11110 of FIG. 11, or network node 13300 of FIG. 13). For example, modules may be stored in memory 13304 of FIG. 13, and/or in first ML model 13324/second ML model 13326, and these modules may provide instructions so that when the instructions of a module are executed by processing circuitry 13302 of FIG. 13, the network node performs respective operations of the method in accordance with various embodiments of the present disclosure.

FIG. 11 shows an example of a network 11100 in accordance with some embodiments.

In the example, the network 11100 includes a telecommunication network 11102 that includes an access network 11104, such as a RAN, and a core network 11106, which includes one or more core network nodes 1118. The access network 1114 includes one or more access nodes, such as network nodes 11110a and 11110b (one or more of which may be generally referred to as network nodes 11110), or any other similar 3GPP access node or non-3GPP access point. The network nodes 11110 facilitate direct or indirect connection of UE, such as by connecting UEs 11102a, 11102b, 11102c, and 11102d (one or more of which may be generally referred to as UEs 11102) and/or computing devices 11114 to the core network 11106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the network 11110 may include any number of wired or wireless networks, network nodes, UEs, computing devices, and/or any other components or systems that may facilitate or participate in the communication of data and/or signals whether via wired or wireless connections. The network 11100 may include and/or interface with any type of communication, telecommunication, data, cellular, radio network, and/or other similar type of system.

The UEs 11112 may be any of a wide variety of communication devices, including wireless devices arranged, configured, and/or operable to communicate wirelessly with the network nodes 11110 and other communication devices. Similarly, the nodes 11110 are arranged, capable, configured, and/or operable to communicate directly or indirectly with the UEs 11112 and/or with other nodes or equipment in the telecommunication network 11102 to enable and/or provide network access, such as wireless network access, and/or to perform other functions, such as administration in the telecommunication network 11102.

In the depicted example, the core network 11106 connects the network nodes 11110 to one or more hosts, such as host 11116. These connections may be direct or indirect via one or more intermediary networks or devices. In other examples, nodes may be directly coupled to hosts. The core network 11106 includes one more core network nodes (e.g., core network node 11108) that are structured with hardware and software components. Features of these components may be substantially similar to those described with respect to the UEs, nodes, and/or hosts, such that the descriptions thereof are generally applicable to the corresponding components of the core network node 11108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 11116 may be under the ownership or control of a service provider other than an operator or provider of the access network 11104 and/or the telecommunication network 11102, and may be operated by the service provider or on behalf of the service provider. The host 11116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the network 11100 of FIG. 11 enables connectivity between the network nodes, computing devices, UEs, and hosts. In that sense, the network may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 11102 is a cellular network that implements 3GPP standardized features. Accordingly, the telecommunications network 11102 may support network slicing to provide different logical networks to different devices that are connected to the telecommunication network 11102. For example, the telecommunications network 11102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, network 11100 is not limited to including a RAN, and rather includes any that includes any programmable/configurable decentralized access point or network element that also records data from performance measurement points in the network.

In some examples, computing devices 1114 are configured as a computer without radio/baseband, etc. attached.

In some examples, the UEs 11112 are configured to transmit and/or receive information without direct human interaction. For instance, a UE may be designed to transmit information to the access network 11104 on a predetermined schedule, when triggered by an internal or external event, or in response to requests from the access network 11104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

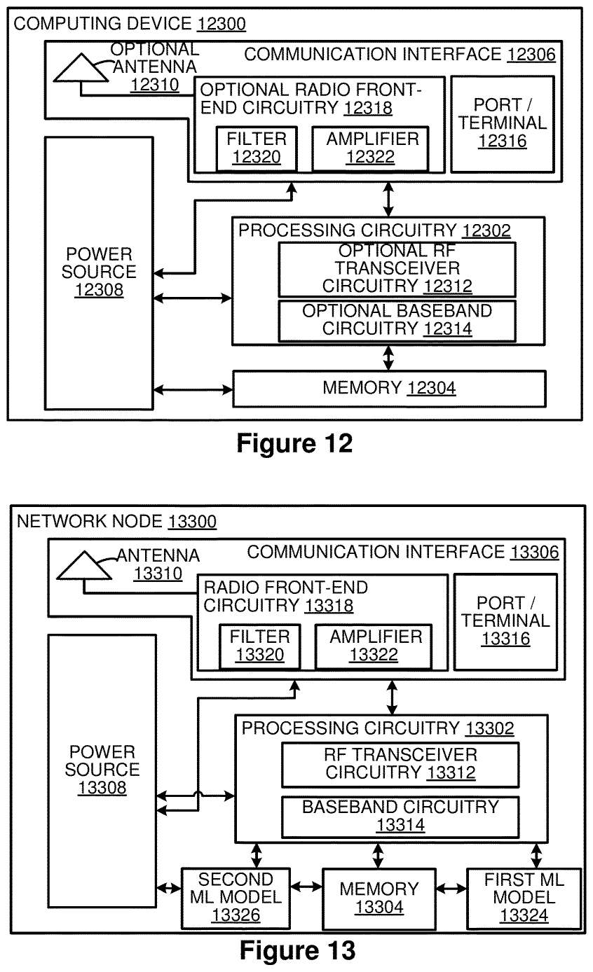

FIG. 12 shows a computing device 12300 in accordance with some embodiments. As previously discussed, a computing device refers to equipment capable, configured, arranged, and/or operable to be programmed to execute a configuration for the computing device. As discussed further herein, examples of computing devices include, but are not limited to, a customer node in the network, a node communicatively connected to a customer node in the network, etc. The computing device 12300 includes processing circuitry 12302 that is operatively coupled via a bus 12204 to an input/output interface 12306, a power source 12308, a memory 12304, a communication interface 12306, and/or any other component, or any combination thereof. Certain computing devices may utilize all or a subset of the components shown in FIG. 12. The level of integration between the components may vary from one computing device to another computing device. Further, certain computing devices may contain multiple instances of a component, such as multiple processors, memories, transceivers, transmitters, receivers, etc.

The processing circuitry 12302 is configured to process instructions and data and may be configured to implement any sequential state machine operative to execute instructions stored as machine-readable computer programs in the memory 12304. The processing circuitry 12302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 12302 may include multiple central processing units (CPUs).

In the example, the input/output interface 12306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the computing device 12300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 12308 is structured as a battery or battery pack. Other types of power sources, such as an external power source (e.g., an electricity outlet), photovoltaic device, or power cell, may be used. The power source 12308 may further include power circuitry for delivering power from the power source 12308 itself, and/or an external power source, to the various parts of the computing device 12300 via input circuitry or an interface such as an electrical power cable. Delivering power may be, for example, for charging of the power source 12308. Power circuitry may perform any formatting, converting, or other modification to the power from the power source 12308 to make the power suitable for the respective components of the computing device 12300 to which power is supplied.

The memory 12304 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 12304 includes one or more application programs, such as an operating system, web browser application, a widget, gadget engine, or other application, and corresponding data. The memory 12304 may store, for use by the computing device 12300, any of a variety of various operating systems or combinations of operating systems.

The memory 12304 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 12304 may allow the computing device 12300 to access instructions, application programs and the like, stored on transitory or non-transitory memory media, to off-load data, or to upload data. An article of manufacture, such as one utilizing a network may be tangibly embodied as or in the memory 12304, which may be or comprise a device-readable storage medium.

The processing circuitry 12302 may be configured to communicate with an access network or other network using the communication interface 12306. The communication interface 12306 may comprise one or more communication subsystems and may include or be communicatively coupled to an optional antenna 12310. The communication interface 12306 may include one or more transceivers used to communicate, such as by communicating with one or more remote transceivers of another device capable of wireless communication (e.g., another computing device or a network node). Each transceiver may include a transmitter 13318 and/or a receiver 13320 appropriate to provide network communications (e.g., optical, electrical, frequency allocations, and so forth). Moreover, the optional transmitter 12318 and receiver 12320 may be coupled to one or more optional antennas (e.g., antenna 12310) and may share circuit components, software or firmware, or alternatively be implemented separately.

In the illustrated embodiment, communication functions of the communication interface 12306 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

FIG. 13 shows a network node 13300 in accordance with some embodiments. As previously discussed herein, a network node refers to any type of communication network. As discussed further herein, examples of a network include, but are not limited to, a telecommunication network that includes an access network, such as a RAN, and a core network, which includes one or more core network nodes. The access network may include one or more access nodes, or any other similar 3GPP access node or non-3GPP access point. The network nodes may facilitate direct or indirect connection of a computing device over one or more wired or wireless connections.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A node may also include one or more (or all) parts of a distributed base station such as centralized digital units and/or remote radio units (RRUs), sometimes referred to as Remote Radio Heads (RRHs). Such remote radio units may or may not be integrated with an antenna as an antenna integrated radio. Parts of a distributed base station may also be referred to as nodes in a distributed antenna system (DAS).

Other examples of network nodes include, without limitation, multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 13300 includes a processing circuitry 13302, a memory 13304, a communication interface 13306, and a power source 13308. The network node 13300 may be composed of multiple physically separate components (e.g., a NodeB component and a RNC component, or a BTS component and a BSC component, etc.), which may each have their own respective components. In certain scenarios in which the network node 13300 comprises multiple separate components (e.g., BTS and BSC components), one or more of the separate components may be shared among several nodes. For example, a single RNC may control multiple NodeBs. In such a scenario, each unique NodeB and RNC pair, may in some instances be considered a single separate node. In some embodiments, the network node 13300 may be configured to support multiple radio access technologies (RATs). In such embodiments, some components may be duplicated (e.g., separate memory 13304 for different RATs) and some components may be reused (e.g., a same antenna 13310 may be shared by different RATs). The network node 13300 may also include multiple sets of the various illustrated components for different wireless technologies integrated into network node 13300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 13300.

The processing circuitry 13302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 13300 components, such as the memory 13304, to provide network node 13300 functionality.

In some embodiments, the processing circuitry 13302 includes a system on a chip (SOC). In some embodiments, the processing circuitry 13302 includes one or more of radio frequency (RF) transceiver circuitry 13312 and baseband processing circuitry 13314. In some embodiments, the radio frequency (RF) transceiver circuitry 13312 and the baseband processing circuitry 13314 may be on separate chips (or sets of chips), boards, or units, such as radio units and digital units. In alternative embodiments, part or all of RF transceiver circuitry 13312 and baseband processing circuitry 13314 may be on the same chip or set of chips, boards, or units.

The memory 13304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 13302. The memory 13304, first ML model 13324, and/or second ML model 13326 may store any suitable instructions, data, or information, including a computer program, software, an application including one or more of logic, rules, code, tables, and/or other instructions capable of being executed by the processing circuitry 13302 and utilized by the network node 13300. The memory 13304, first ML model 13324, and/or second ML model 13326 may be used to store any calculations made by the processing circuitry 13302 and/or any data received via the communication interface 13306. In some embodiments, the processing circuitry 13302, memory 13304, first ML model 13324, and/or second ML model 13326 is integrated.

The communication interface 13306 is used in wired or wireless communication of signaling and/or data between a node, access network, and/or UE. As illustrated, the communication interface 13306 comprises port(s)/terminal(s) 13316 to send and receive data, for example to and from a network over a wired connection. The communication interface 13306 also includes radio front-end circuitry 13318 that may be coupled to, or in certain embodiments a part of, the antenna 13310. Radio front-end circuitry 13318 comprises filters 13320 and amplifiers 13322. The radio front-end circuitry 13318 may be connected to an antenna 13310 and processing circuitry 13302. The radio front-end circuitry may be configured to condition signals communicated between antenna 13310 and processing circuitry 13302. The radio front-end circuitry 13318 may receive digital data that is to be sent out to other network nodes or UEs via a wireless connection. The radio front-end circuitry 13318 may convert the digital data into a radio signal having the appropriate channel and bandwidth parameters using a combination of filters 13320 and/or amplifiers 13322. The radio signal may then be transmitted via the antenna 13310. Similarly, when receiving data, the antenna 13310 may collect radio signals which are then converted into digital data by the radio front-end circuitry 13318. The digital data may be passed to the processing circuitry 13302. In other embodiments, the communication interface may comprise different components and/or different combinations of components.

In certain alternative embodiments, the network node 13300 does not include separate radio front-end circuitry 13318, instead, the processing circuitry 13302 includes radio front-end circuitry and is connected to the antenna 13310. Similarly, in some embodiments, all or some of the RF transceiver circuitry 13312 is part of the communication interface 13306. In still other embodiments, the communication interface 13306 includes one or more ports or terminals 13316, the radio front-end circuitry 13318, and the RF transceiver circuitry 13312, as part of a radio unit (not shown), and the communication interface 13306 communicates with the baseband processing circuitry 13314, which is part of a digital unit (not shown).

The antenna 13310 may include one or more antennas, or antenna arrays, configured to send and/or receive wireless signals. The antenna 13310 may be coupled to the radio front-end circuitry 13318 and may be any type of antenna capable of transmitting and receiving data and/or signals wirelessly. In certain embodiments, the antenna 13310 is separate from the network node 13300 and connectable to the network node 13300 through an interface or port.

The antenna 13310, communication interface 13306, and/or the processing circuitry 13302 may be configured to perform any receiving operations and/or certain obtaining operations described herein as being performed by the node. Any information, data and/or signals may be received from a computing device, another node and/or any other network equipment. Similarly, the antenna 13310, the communication interface 13306, and/or the processing circuitry 13302 may be configured to perform any transmitting operations described herein as being performed by the network node. Any information, data and/or signals may be transmitted to a computing device, another node and/or any other network equipment.

The power source 13308 provides power to the various components of network node 13300 in a form suitable for the respective components (e.g., at a voltage and current level needed for each respective component). The power source 13308 may further comprise, or be coupled to, power management circuitry to supply the components of the network node 13300 with power for performing the functionality described herein. For example, the network node 13300 may be connectable to an external power source (e.g., the power grid, an electricity outlet) via an input circuitry or interface such as an electrical cable, whereby the external power source supplies power to power circuitry of the power source 13308. As a further example, the power source 13308 may comprise a source of power in the form of a battery or battery pack which is connected to, or integrated in, power circuitry. The battery may provide backup power should the external power source fail.

Embodiments of the network node 13300 may include additional components beyond those shown in FIG. 13 for providing certain aspects of the network node's functionality, including any of the functionality described herein and/or any functionality necessary to support the subject matter described herein. For example, the network node 13300 may include user interface equipment to allow input of information into the network node 13300 and to allow output of information from the network node 13300. This may allow a user to perform diagnostic, maintenance, repair, and other administrative functions for the network node 13300.

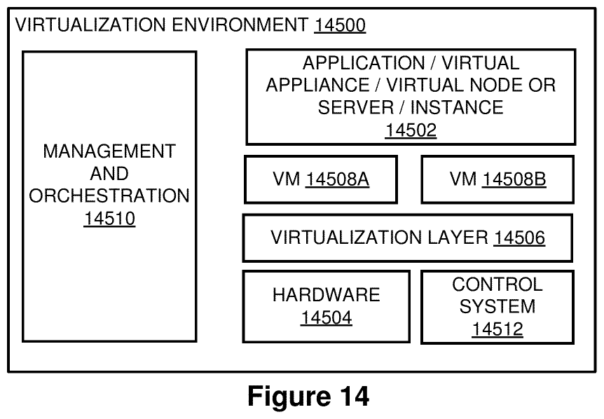

FIG. 14 is a block diagram illustrating a virtualization environment 14500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 14500 hosted by one or more of hardware nodes, such as a hardware computing device that operates as a network node, computing device, core network node, or host. Further, in embodiments in which the virtual node does not require radio connectivity (e.g., a core network node or host), then the node may be entirely virtualized.

Applications 14502 (which may alternatively be called software instances, virtual appliances, network functions, virtual nodes, virtual network functions, etc.) are run in the virtualization environment 14500 to implement some of the features, functions, and/or benefits of some of the embodiments disclosed herein.

Hardware 14504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 14506 (also referred to as hypervisors or virtual machine monitors (VMMs)), provide VMs 14508a and 14508b (one or more of which may be generally referred to as VMs 14508), and/or perform any of the functions, features and/or benefits described in relation with some embodiments described herein. The virtualization layer 14506 may present a virtual operating platform that appears like networking hardware to the VMs 14508.

The VMs 14508 comprise virtual processing, virtual memory, virtual networking or interface and virtual storage, and may be run by a corresponding virtualization layer 14506. Different embodiments of the instance of a virtual appliance 14502 may be implemented on one or more of VMs 14508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 14508 may be a software implementation of a physical machine that runs programs as if they were executing on a physical, non-virtualized machine. Each of the VMs 14508, and that part of hardware 14504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 14508 on top of the hardware 14504 and corresponds to the application 14502.

Hardware 14504 may be implemented in a standalone network node with generic or specific components. Hardware 14504 may implement some functions via virtualization. Alternatively, hardware 14504 may be part of a larger cluster of hardware (e.g. such as in a data center or CPE) where many hardware nodes work together and are managed via management and orchestration 14510, which, among others, oversees lifecycle management of applications 14502. In some embodiments, hardware 14504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 14512 which may alternatively be used for communication between hardware nodes and radio units.

Although the network nodes described herein may include the illustrated combination of hardware components, other embodiments may comprise computing devices with different combinations of components. It is to be understood that these network nodes may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A computer-implemented method performed by a network node to generate and return a configuration of a computing device in a network, the method comprising:
receiving data comprising (i) an observation for the computing device or the network for a second time interval, the observation comprising one or more of a plurality of configurations of the computing device, a plurality of performance metrics, and/or a plurality of key performance indicators, KPIs, and (ii) an intent comprising one or more of a performance metric, a KPI, and a configuration parameter;
generating with a first machine learning, ML, model, a plurality of configurations for the computing device for the second time interval based on a search on a plurality of latent variables in a latent space;
returning from the search, a configuration for the computing device for the second time interval that best satisfies the performance metric and/or the KPI of the intent based on the search, wherein the configuration is constrained by at least one of the performance metric, the KPI, and the configuration parameter of the intent; and
transmitting the configuration for the computing device.

2. The method of claim 1, wherein the search on the plurality of latent variables in the latent space comprises one or more of (1) encoding the plurality of configurations of the computing device, the plurality of performance metrics, and/or the plurality of KPIs of the data to a compressed representation in the latent space, (2) sampling a plurality of points in the latent space, (3) decoding respective points in the plurality of points in the latent space to a respective plurality of decoded points, and (4) generating the configuration for the computing device on the performance metric and/or the KPI while satisfying the constrained at least one of the performance metric, the configuration parameter, and the KPI.

3. The method of claim 1, wherein the data comprises data for a first time interval, wherein a portion of the first time interval comprises missing data.

4. The method of claim 2, wherein the sampling comprises accessing an association of a plurality of constraints comprising one or more of the KPI, the performance metric, and the configuration parameter.

5. The method of claim 1, further comprising:
receiving a raw observation for the computing device and/or the network for a first time interval, the raw observation comprising one or more of a plurality of configurations of the computing device, a plurality of performance metrics, and/or a plurality of KPIs; and
dividing the raw observation into categorical data and numerical data.

6. The method of claim 5, wherein the categorical data comprises categorical data for the first time interval having a value and categorical data for the first time interval having a missing value, the method further comprising:
ordinally-encoding the categorical data having the missing value with the categorical data having a value;
scaling the numerical data; and
joining the ordinally encoded categorical data and the numerical data.

7. The method of claim 6, further comprising:
performing an embedded lookup process on the categorical data.

8. The method of claim 7, wherein the embedded lookup process comprises one or more of (i) embedding the categorical data in an embedded association; and (ii) encoding the categorical data based on the embedded association.

9. The method of claim 7, further comprising:
performing a reverse lookup process on the embedded lookup process on the generation of a configuration from the first ML model.

10. The method of claim 9, wherein the reverse lookup process comprises one or more of (i) dividing the generated configuration from the first ML model into a plurality of respective embedding vectors and a plurality of respective numerical vectors, wherein a respective embedding vector represents a single categorical feature of the categorical data;
(ii) normalizing the respective embedding vectors and an association of a plurality of constraints comprising one or more of the KPI, the performance metric, and the configuration parameter;
(iii) calculating a product of the normalized plurality of respective embedding vectors and the normalized embedded association data;
(iv) applying a normalizing function to the product to obtain a distribution over values for the configuration.

11. The method of claim 1, further comprising:
training the first ML model, wherein during the training a cross-entropy loss is calculated for a distribution over values for the configuration.

12. The method of claim 1, when the data comprises one of a categorical data with a missing value or a numerical data with a missing value.

13. The method of claim 12, wherein when the numerical data has a missing value, the method further comprises:
imputing the missing value with zeroes; and
joining the numerical data having values with the numerical data having zero-imputed values.

14. The method of claim 12, wherein when a categorial data has a missing value, the method further comprises:
ordinally-encoding the categorical data having the missing value with categorical data having a value; and
adding the ordinally-encoded data to an association of a plurality of constraints, wherein the association comprises one or more of a plurality of KPIs, a plurality of performance metrics, and a plurality of configuration parameters.

15. The method of any claim 1, further comprising:
generating, from a second ML model, a predicted observation for the computing device and/or the network for the second time interval, wherein the generating comprises propagating the data from the first time interval into the future for the second time interval, the propagating comprising predicting the observation and predicting a latent encoding.

16. The method of claim 15, wherein the second ML model comprises a long short term memory, LSTM, model and the predicting the predicted observation is performed with the LSTM model and wherein the generating comprises using the predicted observation to find the configuration.

17. The method of claim 1, wherein the computing device has a current configuration management setting, the performance metric comprises an energy performance metric, the KPI comprises a performance metric of the network, and the configuration of the computing device comprises another configuration management setting for the computing device.

18.-19. (canceled)

20. The method of claim 1, wherein the network node comprises a node in a networks data analytics function, NWDAF.

21. (canceled)

22. A network node configured to generate and return a configuration of a computing device in a network, the network node comprising:
processing circuitry;
memory coupled with the processing circuitry, wherein the memory includes instructions that when executed by the processing circuitry causes the network node to perform operations comprising:
receive data comprising (i) an observation for the computing device or the network for a second time interval, the observation comprising one or more of a plurality of configurations of the computing device, a plurality of performance metrics, and/or a plurality of key performance indicators, KPIs, and (ii) an intent comprising one or more of a performance metric, a KPI, and a configuration parameter;
generate, with a first machine learning, ML model, a plurality of configurations for the computing device for the second time interval based on a search on a plurality of latent variables in a latent space;
return, from the search, a configuration for the computing device for the second time interval that best satisfies the performance metric and/or the KPI of the intent based on a search on the plurality of latent variables in the latent space, wherein the configuration is constrained by at least one of the performance metric, the KPI, and the configuration parameter of the intent; and
transmit the configuration for the computing device.

23. The network node of claim 22, wherein the memory includes instructions that when executed by the processing circuitry causes the network node to perform further operations comprising receiving data comprising an observation for the computing device or the network for a second time interval, the observation comprising one or more of a plurality of configurations of the computing device, a plurality of performance metrics, and/or a plurality of key performance indicators, KPIs, and an intent comprising one or more of a performance metric, a KPI, and a configuration parameter;
generating, with a first machine learning, ML, model, a plurality of configurations for the computing device for the second time interval based on a search on a plurality of latent variables in a latent space;
returning, from the search, a configuration for the computing device for the second time interval that best satisfies the performance metric and/or the KPI of the intent based on the search, wherein the configuration is constrained by at least one of the performance metric, the KPI, and the configuration parameter of the intent; and
transmitting the configuration for the computing device,
wherein the search on the plurality of latent variables in the latent space comprises one or more of encoding the plurality of configurations of the computing device, the plurality of performance metrics, and/or the plurality of KPIs of the data to a compressed representation in the latent space, sampling a plurality of points in the latent space, decoding respective points in the plurality of points in the latent space to a respective plurality of decoded points, and generating the configuration for the computing device on the performance metric and/or the KPI while satisfying the constrained at least one of the performance metric, the configuration parameter, and the KPI.

24.-29. (canceled)
